(19) United States
(12) Patent Application Publication
(10) Pub. No.: US 2021/0303995 A1
(43) Pub. Date: Sep. 30, 2021

(54) DEEP PARTIAL TRANSFER METHOD WEIGHTED BY DOMAIN ASYMMETRY FACTORS FOR ROLLING BEARING FAULT DIAGNOSIS

(71) Applicant: Xi'an Jiaotong University, Xi'an (CN)

(72) Inventors: Bin YANG, Xi'an (CN); Yaguo LEI, Xi'an (CN); Naipeng LI, Xi'an (CN); Xiaosheng SI, Xi'an (CN)

(73) Assignee: Xi'an Jiaotong University, Xi'an (CN)

(21) Appl. No.: 16/908,755

(22) Filed: Jun. 23, 2020

(30) Foreign Application Priority Data
Mar. 27, 2020 (CN) 202010226934.2

(51) Int. Cl. G06N 3/08; G06N 3/04; G07C 3/08

(52) U.S. Cl. CPC G06N 3/08; G06F 17/11; G07C 3/08; G06N 3/0454

(57) ABSTRACT

A deep partial transfer method weighted by a domain asymmetry factor for rolling bearing fault diagnosis includes: first, extracting the deep transfer fault features from the monitoring data of the source rolling bearing and the target rolling bearing by a deep residual network; second, training the domain confusion network by using the deep transfer fault feature, and calculating the domain asymmetric factor; next, calculating the maximum mean discrepancy implanted by a multiple polynomial kernels of the fault features of the adaptation layer of the deep residual network, and using the domain asymmetry factor weighting to suppress the contribution of outlier fault features of the source rolling bearing; and finally, building the objective function using the weighted maximum mean discrepancy implanted by the multiple polynomial kernels to train the deep residual network.

### CROSS REFERENCE TO THE RELATED APPLICATIONS

This application is based upon and claims priority to Chinese Patent Application No. 202010226934.2, filed on Mar. 27, 2020, the entire contents of which are incorporated herein by reference.

### TECHNICAL FIELD

The present invention belongs to the technical field of rolling bearing fault diagnosis, and more specifically, to a deep partial transfer method weighted by domain asymmetry factors for rolling bearing fault diagnosis.

### BACKGROUND

The rolling bearing is a major and key component in large rotating machinery. The bearing faults will cause substantial economic loss, and even seriously endanger people's lives and property. It is, therefore, crucial to perform in-service condition monitoring on the rolling bearings. Intelligent fault diagnosis utilizes advanced machine learning technology to build a mapping relationship between bearing monitoring data and health states, which significantly reduces the excessive reliance on experts' prior knowledge in the diagnostic process. With the rapid development of deep learning technology in recent years, the intelligent level and diagnostic accuracy of intelligent fault diagnosis have been dramatically improved. This has become an important means to ensure the safe operation of bearings. The intelligent fault diagnosis requires a large number of labeled samples to sufficiently train the diagnostic model. However, in engineering practice, the scarcity of labeled samples severely limits the practical application of the intelligent fault diagnosis. Transfer learning, by establishing a transfer diagnostic model, can utilize fault diagnosis knowledge of the source rolling bearing to solve the fault diagnosis problem of the target rolling bearing, which promotes the practical application of the intelligent fault diagnosis of rolling bearings.

Existing transfer diagnostic techniques for rolling bearings have significant limitations: namely, the diagnostic knowledge domains of the source bearing and the target bearing need to be symmetrical, which requires (1) the data of the target bearing are evenly balanced across every health states, and (2) the size of the label space of the source bearing monitoring data is equal to the size of the label space of the target bearing data. In engineering practice, however, these two requirements generally cannot be satisfied due to the following problems. The target bearing is in the normal state for a long time during the in-service monitoring. As a result, the fault state is significantly less frequent compared with the normal state. Therefore, the collected data are imbalanced to include a large amount of normal information and a small amount of fault information. Additionally, the fault state generated by the source bearing may not occur on the target bearing The label space of the source rolling bearing data generally covers the label space of the target bearing. This causes asymmetrical diagnostic knowledge domains between the source bearing and the target bearing.

Due to the influences of the asymmetry of the diagnostic knowledge domain, the existing transfer diagnostic techniques are difficult to effectively use the diagnostic knowledge of the source bearing to identify the imbalanced health states of the target bearing.

### SUMMARY

In order to overcome the shortcomings of the prior art, an objective of the present invention is to provide a deep partial transfer method weighted by domain asymmetry factors for rolling bearing fault diagnosis, which improves the transfer diagnostic accuracy of the rolling bearing under the domain asymmetry constraint, and promotes the practical application of intelligent diagnostic techniques.

To achieve the above-mentioned objective, the present invention adopts the following technical solution:

A deep partial transfer method weighted by domain asymmetry factors for rolling bearing fault diagnosis, including the following steps:

step 1: obtaining a vibration signal sample set

$${\{ ( {x}_{m}^{s} , {y}_{m}^{s} ) \}}_{m = 1}^{{M}_{s}}$$

of a source rolling bearing in R types of health state, where xₘ^{s}∈ [symbol] ^{N×1} represents the m^{th} health state sample of the source rolling bearing and includes N vibration data points, the sample label of the health state sample is yₘ^{s} ∈{1, 2, 3, . . . R}, Mₛ represents the total number of vibration signal samples of the source rolling bearing, and s represents the source rolling bearing; obtaining a vibration signal sample set

$${\{ {x}_{n}^{t} \}}_{n = 1}^{{M}_{t}}$$

of a target rolling bearing, where xₙ^{t} ∈ [symbol] ^{N×1} represents the n^{th} unlabeled health state sample of the target rolling bearing and includes N vibration data points, Mₜ represents the total number of vibration signal samples of the target rolling bearing, and t represents the target rolling bearing;

step 2: building a domain-shared deep residual network, wherein the parameter to be trained in the network is θ_{ResNet}, and extracting the deep transfer fault features

$${\{ {x}_{m}^{s , {F}_{1}} \}}_{n = 1}^{{M}_{s}} and {\{ {x}_{n}^{t , {F}_{1}} \}}_{n = 1}^{{M}_{t}}$$

from the vibration signal sample set of the source rolling bearing and the vibration signal sample set of the target rolling bearing, respectively, where xₘ^{s,F}^{₁} represents the deep transfer fault feature of the m^{th} health state sample of the source rolling bearing, xₙ^{t,F}^{₁} represents the deep transfer fault feature of the n^{th} health state sample of the target rolling bearing, and F₁ represents an F₁ layer of the deep residual network;

step 3: building a parameter-shared domain confusion network, wherein the parameter to be trained in the domain confusion network is θ_{adv}, the input of the domain confusion network is the deep transfer fault features

$${\{ {x}_{m}^{s , {F}_{1}} \}}_{m = 1}^{{M}_{s}} and {\{ {x}_{n}^{t , {F}_{1}} \}}_{n = 1}^{{M}_{t}} ,$$

and the output of the domain confusion network is the domain confusion features

$${\{ {x}_{m}^{s , adv} \}}_{m = 1}^{{M}_{s}} and {\{ {x}_{n}^{t , adv} \}}_{n = 1}^{{M}_{t}} ,$$

where xₘ^{s,adv} represents the domain confusion feature of the m^{th} health state sample of the source rolling bearing, xₙ^{t,adv} represents the domain confusion feature of the n^{th} health state sample of the target rolling bearing, and adv represents the domain confusion network; and maximizing the following objective function to update the parameter θ_{adv} of the domain confusion network:

$${max}_{{θ}_{a d v}} {\sum }_{m = 1}^{{M}_{s}} {x}_{m}^{s , adv} - {\sum }_{n = 1}^{{M}_{t}} {x}_{n}^{t , adv}$$

wherein, after being updated in each iteration, the parameter θ_{adv} to be trained in the domain confusion network is truncated within the range of {−ξ, ξ};

step 4: after the parameter θ_{adv} to be trained in the domain confusion network is iteratively updated n_{adv} times in step 3, calculating the domain asymmetry factor ρₘ^{s} for the deep transfer feature of the m^{th} health state sample of the source rolling bearing;

step 5: extracting the fault features

$${\{ {x}_{m}^{s , {F}_{2}} \}}_{m = 1}^{{M}_{s}} and {\{ {x}_{n}^{t , {F}_{2}} \}}_{n = 1}^{{M}_{t}}$$

of an adaptation layer of the F₂ layer of the deep residual network, where xₘ^{s,F}^{₂} represents the fault feature of the adaptation layer of the m^{th} health state sample of the source rolling bearing, and xₙ^{t,F}^{₂} represents the fault feature of the adaptation layer of the n^{th} health state sample of the target rolling bearing, and F₂ represents the F₂ layer (feature adaptation layer) of the deep residual network; and calculating a maximum mean discrepancy D(X^{s}, X^{t}) implanted by a multiple polynomial kernels of the adaptation layer features by weighting the domain asymmetry factor obtained in step 4:

$$D ( {X}^{s} , {X}^{t} ) = {\sum }_{u = 1}^{U} {β}_{u} D ( {X}^{s} , {X}^{t} ; {a}_{u} ) = {\sum }_{u = 1}^{U} {β}_{u} \\ [ \begin{matrix}\frac{1}{{M}_{s}^{2}} {\sum }_{i = 1}^{{M}_{s}} {\sum }_{j = 1}^{{M}_{s}} {ρ}_{i}^{s} {ρ}_{j}^{s} k ( {x}_{i}^{s , {F}_{2}} , {x}_{j}^{s , {F}_{2}} ; {a}_{u} ) + \frac{1}{{M}_{t}^{2}} {\sum }_{i = 1}^{{M}_{t}} {\sum }_{j = 1}^{{M}_{t}} k ( {x}_{i}^{t , {F}_{2}} , {x}_{j}^{t , {F}_{2}} ; {a}_{u} ) \\ - \frac{2}{{M}_{s} {M}_{t}} {\sum }_{i = 1}^{{M}_{s}} {\sum }_{j = 1}^{{M}_{t}} {ρ}_{i}^{s} k ( {x}_{i}^{s , {F}_{2}} , {x}_{j}^{t , {F}_{2}} ; {a}_{u} )\end{matrix} ]$$

where, k(⋅,⋅) represents a polynomial kernel function; aᵤ represents a slope of the u^{th} polynomial kernel function; U represents the number of the implanted polynomial kernel functions; βᵤ represents a weighting coefficient of the maximum mean discrepancy implanted by the u^{th} polynomial kernel, and βᵤ∈β*, where β* represents the optimal weighting coefficient and is obtained by solving the following optimization problem:

$${β}^{*} = {arg max}_{{β}_{u}} \frac{{\sum }_{u = 1}^{U} {β}_{u} D ( {X}^{s} , {X}^{t} ; {a}_{u} )}{\sqrt{\frac{1}{U} {\sum }_{u = 1}^{U} {[ {β}_{u} D ( {X}^{s} , {X}^{t} ; {a}_{u} ) - \frac{1}{U} {\sum }_{u = 1}^{U} {β}_{u} D ( {X}^{s} , {X}^{t} ; {a}_{u} ) ]}^{2}}}$$

$$where , {\sum }_{u = 1}^{U} {β}_{u} = 1 , and {β}_{u} \geq 0.$$

step 6: predicting the probability distribution

$${\{ {P}_{m}^{s , {F}_{3}} \}}_{m = 1}^{{M}_{s}} and {\{ {P}_{n}^{t , {F}_{3}} \}}_{n = 1}^{{M}_{t}}$$

of the F₃ layer feature of the deep residual network belonging to the health state of the source and target rolling bearings by a Softmax activation function, where Pₘ^{s,F}^{₃} represents a predicted probability distribution of the health state of the m^{th} vibration sample of the source rolling bearing, and Pₙ^{t,F}^{₃} represents a predicted probability distribution of the health state of the n^{th} vibration sample of the target rolling bearing, and F₃ represents the output layer F₃ layer of the deep residual network; and minimizing the following objective function to update the parameter θ_{adv} to be trained in the deep residual network by combining the maximum mean discrepancy that is implanted by the multiple polynomial kernels and obtained in step 5:

$${min}_{θ} - \frac{1}{{M}_{s}} {\sum }_{m = 1}^{{M}_{s}} {\sum }_{j = 1}^{R} I ( {y}_{m}^{s} = j ) log {P}_{m}^{s , {F}_{3}} + λ \cdot D ( {X}^{s} , {X}^{t} )$$

where, λ represents a tradeoff parameter for the training of the deep residual network; and

step 7: repeating steps 3-6 in sequence to train the partial transfer diagnostic model combined by the domain confusion network and the deep residual network; after the training of partial transfer diagnostic model is done, inputting the n^{th} unlabeled health sample xₙ^{t} of the target rolling bearing into the deep residual network of the partial transfer diagnostic model; selecting a health label corresponding to the maximum probability value in the probability distribution Pₙ^{t,F}^{₃} of the health state of the vibration sample of the target rolling bearing output by the deep confusion network as the health state of the n^{th} unlabeled health sample xₙ^{t} of the target rolling bearing.

The advantages of the present invention are as follows. The present invention provides a deep partial transfer method weighted by a domain asymmetry factor for rolling bearing fault diagnosis. The method (i) constructs the domain confusion network for adaptive learning of the domain asymmetry factor, (ii) utilizes this factor weighting to suppress the influence of outlier deep transfer fault features of the source rolling bearing on the feature distribution adaption, and (iii) identifies the imbalanced health state of the target rolling bearing by using the partial diagnostic knowledge in the source rolling bearing. The method thus overcomes the limitations of the domain asymmetry on current transfer diagnostic techniques in practical engineering, and improves the transfer diagnostic accuracy of rolling bearing fault under the constraint of the domain asymmetry factor.

### BRIEF DESCRIPTION OF THE DRAWINGS

FIG. 1 shows the flow chart of the present invention.

FIG. 2 is a schematic diagram showing the partial transfer diagnostic model of the present invention.

### DETAILED DESCRIPTION OF THE EMBODIMENTS

The present invention is further described hereinafter with reference to the drawings and embodiments.

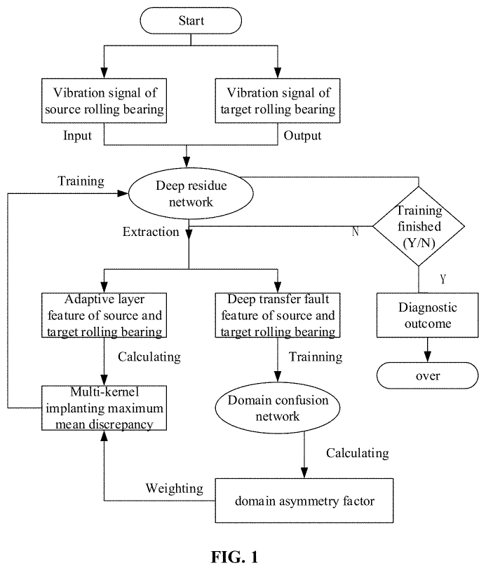

As shown in FIG. 1, the deep partial transfer method weighted by a domain asymmetry factor for rolling bearing fault diagnosis includes the following steps:

Step 1: The vibration signal sample set

$${\{ ( {x}_{m}^{s} , {y}_{m}^{s} ) \}}_{m = 1}^{{M}_{s}}$$

of the source rolling bearing in R types of health state is obtained, where xₘ^{s}∈ [symbol] ^{N×1} represents the m^{th} health state sample of the source rolling bearing and includes N vibration data points, and the sample label of the health state sample is yₘ^{s}∈{1, 2, 3, . . . R}; Mₛ represents the total number of vibration signal samples of the source rolling bearing; s represents the source rolling bearing. The vibration signal sample set

$${\{ {x}_{n}^{t} \}}_{n = 1}^{{M}_{t}}$$

of the target rolling bearing is obtained, where xₙ^{t}∈ [symbol] ^{N×1} represents the n^{th} unlabeled health state sample of the target rolling bearing and includes N vibration data points; Mₜ represents the total number of vibration signal samples of the target rolling bearing, and t represents the target rolling bearing.

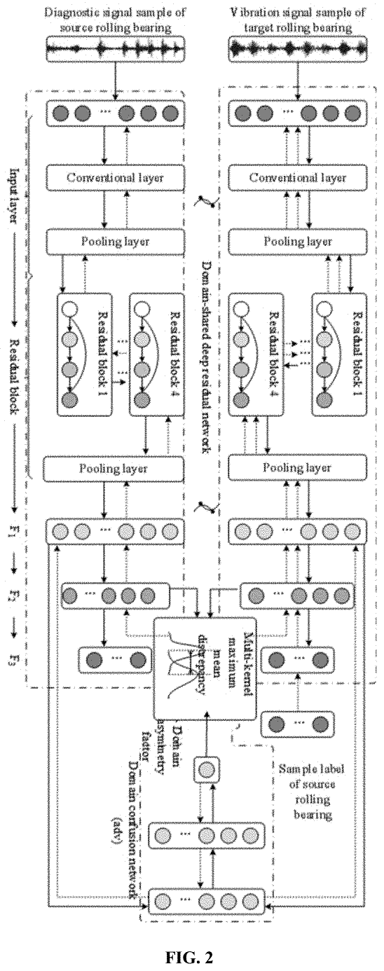

Step 2: Referring to FIG. 2, a domain-shared deep residual network is built, wherein the parameter to be trained in the deep residual network is θ_{ResNet}. The deep residual network stacks convolutional layers, pooling layers and the plurality of residual blocks, and concurrently extracts the deep transfer fault features

$${\{ {x}_{m}^{s , {F}_{1}} \}}_{n = 1}^{{M}_{s}} and {\{ {x}_{n}^{t , {F}_{1}} \}}_{n = 1}^{{M}_{t}}$$

from the vibration signal sample set of the source rolling bearing and the vibration signal sample set of the target rolling bearing, where xₘ^{s,F}^{₁} represents the deep transfer fault feature of the m^{th} health state sample of the source rolling bearing, xₘ^{t,F}^{₁} represents the deep transfer fault feature of the n^{th} health state sample of the target rolling bearing, and F₁ represents the F₁ layer of the deep residual network, as shown in FIG. 2.

Step 3: Referring to FIG. 2, the parameter-shared domain confusion network is built. The parameter to be trained in the domain confusion network is θ_{adv}, and the domain confusion network is a multi-hidden layer neural network structure. The input of the domain confusion network is the deep transfer fault features

$${\{ {x}_{m}^{s , {F}_{1}} \}}_{m = 1}^{{M}_{s}} and {\{ {x}_{n}^{t , {F}_{1}} \}}_{n = 1}^{{M}_{t}}$$

obtained in step 2, and the output of the domain confusion network is the domain confusion features

$${\{ {x}_{m}^{s , a d v} \}}_{m = 1}^{{M}_{s}} and {\{ {x}_{n}^{t , adv} \}}_{n = 1}^{{M}_{t}} ,$$

where xₘ^{s,adv} represents the domain confusion feature of the m^{th} health state sample of the source rolling bearing, xₙ^{t,adv} represents the domain confusion feature of the n^{th} health state sample of the target rolling bearing, and adv represents the domain confusion network. The following objective function is maximized to update the parameter θ_{adv} of the domain confusion network:

$${max}_{{θ}_{a d v}} {\sum }_{m = 1}^{{M}_{s}} {x}_{m}^{s , a d v} - {\sum }_{n = 1}^{{M}_{t}} {x}_{n}^{t , adv}$$

After being updated in each iteration, the parameter θ_{adv} to be trained in the domain confusion network is truncated within the range of {−ξ, ξ}.

Step 4: After the parameter θ_{adv} to be trained in the domain confusion network is iteratively updated n_{ad} times in step 3, the domain asymmetry factor ρₘ^{s} for the deep transfer feature of the m^{th} health state sample of the source rolling bearing is calculated by the following formula:

$${ρ}_{m}^{s} = \frac{1 - {σ}_{s igmoid} ( {x}_{m}^{s , adv} )}{\frac{1}{{M}_{s}} {\sum }_{m = 1}^{{M}_{s}} [ 1 - {σ}_{s i g m o i d} ( {x}_{m}^{s , adv} ) ]}$$

$$where , {σ}_{s i g m o i d} ( {x}_{m}^{s , a d v} ) = \frac{1}{1 + exp ( - {x}_{m}^{s , a d v} )}$$

represents a Sigmoid function.

Step 5: Referring to FIG. 2, the F₂ layer and the F₃ layer are stacked in sequence to establish the mapping relationship between the deep transfer fault feature and the health state label of the source rolling bearing. The F₂ layer in FIG. 2 is the feature adaptation layer of the deep residual network. The fault features

$${\{ {x}_{m}^{s , {F}_{2}} \}}_{m = 1}^{{M}_{s}} and {\{ {x}_{n}^{t , {F}_{2}} \}}_{n = 1}^{{M}_{t}}$$

of the adaptation layer are extracted, where xₘ^{s,F}^{₂} represents the fault feature of the adaptation layer of the m^{th} health state sample of the source rolling bearing, xₙ^{t,F}^{₂} represents the fault feature of the adaptation layer of the n^{th} health state sample of the target rolling bearing, and F₂ represents the F₂ layer (feature adaptation layer) of the deep residual network. Then, the maximum mean discrepancy D(X^{s}, X^{t}) implanted by mulitple polynomial kernels is calculated as follows by weighting the domain asymmetric factor obtained in step 4:

$$D ( {X}^{s} , {X}^{t} ) = {\sum }_{u = 1}^{U} {β}_{u} D ( {X}^{s} , {X}^{t} \text{;} {a}_{u} ) = {\sum }_{u = 1}^{U} {β}_{u} [ \begin{matrix}\frac{1}{{M}_{s}^{2}} {\sum }_{i = 1}^{{M}_{s}} {\sum }_{j = 1}^{{M}_{s}} {ρ}_{i}^{s} {ρ}_{j}^{s} k ( {x}_{i}^{s , {F}_{2}} , {x}_{j}^{s , {F}_{2}} \text{;} {a}_{u} ) + \frac{1}{{M}_{t}^{2}} {\sum }_{i = 1}^{{M}_{t}} {\sum }_{j = 1}^{{M}_{t}} k ( {x}_{i}^{t , {F}_{2}} , {x}_{j}^{t , {F}_{2}} \text{;} {a}_{u} ) \\ - \frac{2}{{M}_{s} {M}_{t}} {\sum }_{i = 1}^{{M}_{s}} {\sum }_{j = 1}^{{M}_{t}} {ρ}_{i}^{s} k ( {x}_{i}^{t , {F}_{2}} , {x}_{j}^{t , {F}_{2}} \text{;} {a}_{u} )\end{matrix} ]$$

where, k(⋅,⋅) represents the polynomial kernel function; aᵤ represents the slope of the u^{th} polynomial kernel function; U represents the number of the implanted polynomial kernel functions; βᵤ represents the weighting coefficient of the maximum mean discrepancy implanted by the u^{th} polynomial kernel, and βᵤ∈β*, where β* represents the optimal weighting coefficient and is obtained by solving the following optimization problem:

$${β}^{*} = {arg max}_{{β}_{u}} \frac{{\sum }_{u = 1}^{U} {β}_{u} D ( {X}^{s} , {X}^{t} \text{;} {a}_{u} )}{\sqrt{\frac{1}{U} {\sum }_{u = 1}^{U} {[ {β}_{u} D ( {X}^{s} , {X}^{t} \text{;} {a}_{u} ) - \frac{1}{U} {\sum }_{u = 1}^{U} {β}_{u} D ( {X}^{s} , {X}^{t} \text{;} {a}_{u} ) ]}^{2}}} where , \\ {\sum }_{u = 1}^{U} {β}_{u} = 1 , \\ and {β}_{u} \geq 0.$$

Step 6: Referring to FIG. 2, the F₃ layer in the figure is the output layer of the deep residual network, the probability distribution

$${\{ {x}_{m}^{s , {F}_{3}} \}}_{m = 1}^{{M}_{s}} and {\{ {x}_{n}^{t , {F}_{3}} \}}_{n = 1}^{{M}_{t}}$$

of the F₃ layer feature of the deep residual network belonging to the health state of the source and target rolling bearings is predicted by the Softmax activation function, where Pₘ^{s,F}^{₃} represents the predicted probability distribution of the health state of the m^{th} vibration sample of the source rolling bearing, and Pₙ^{t,F}^{₃} is the probability distribution of the n^{th} health state sample of target rolling bearing, and F₃ represents the output layer F₃ of the deep residual network. Then, the following objective function is minimized to update the parameter θ_{ResNet} to be trained in the deep residual network by combining the maximum mean discrepancy that is implanted by the polynomial kernel and obtained in step 5:

$${min}_{θ} - \frac{1}{{M}_{s}} {\sum }_{m = 1}^{{M}_{s}} {\sum }_{j = 1}^{R} I ( {y}_{m}^{s} = j ) log {P}_{m}^{s , {F}_{3}} + λ \cdot D ( {X}^{s} , {X}^{t} )$$

where, λ represents a tradeoff parameter for the training of the deep residual network.

Step 7: Steps 3-6 are repeated in sequence to train the partial transfer diagnostic model combined by the domain confusion network and the deep residual network. After the training of partial transfer diagnostic model is done, the n^{th} unlabeled health sample xₙ^{t} of the target rolling bearing is input into the deep residual network of the partial transfer diagnostic model. The health state corresponding to the maximum probability value in the probability distribution Pₙ^{t,F}^{₃} of the health sample of the vibration sample of the target rolling bearing output by the deep confusion network is selected as the health state of the n^{h} unlabeled health sample xₙ^{t} of the target rolling bearing.

Embodiment: The identification of the health state of the locomotive wheelset bearing is taken as an example to verify the feasibility of the present invention.

The vibration signal sample set A of the source rolling bearing is derived from the University of Paderborn, as shown in Table 1, the data contain three types of bearing health state: normal state, inner race fault, and outer race fault. The vibration signal samples are obtained in four different working conditions (including 900 r/min, 0.7 N·m, 1 kN; 1500 r/min, 0.1 N·m, 1 kN; 1500 r/min, 0.7 N·m, 1 kN; 1500 r/min, 0.7 N·m, 0.4 kN). The sampling frequency of the vibration signal is 64 kHz during the testing process. 2559 samples are obtained at the end of the test, each type of health state contains 853 samples, and each sample contains 1200 sampling points.

The vibration signal sample set B of the target rolling bearing is derived from the locomotive wheelset bearing, as shown in Table 1, the data set contains two types of bearing health state: normal state and spalling of the outer race surface. The vibration signal samples are collected under the working condition of a 500 r/min rotational speed of the bearing outer race (the inner race is fixed) and a 680 kg radial load at the sampling frequency of 76.8 kHz. The data set contains 832 samples with the normal state and 147 samples with the outer race fault. Each sample contains 1200 sampling points.

TABLE 1
vibration signal sample set of the source rolling
bearing and the target rolling bearing

| Vibration | Bearing | | | |
|---|---|---|---|---|
| sample set | designation | Health state | Sample size | Working condition |
| A | 6203 | Normal | 2559 | 900 r/min, 0.7 N · m, 1 kN |
| (source | | Inner race | (853 × 3) | 1500 r/min, 0.1 N · m, 1 kN |
| rolling | | fault | | 1500 r/min, 0.7 N · m, 1 kN |
| bearing) | | Outer race | | 1500 r/min, 0.7 N · m, 0.4 kN |
| | | fault | | |
| B | 197726 | Normal | 832 | 500 r/m, 680 kg |
| (target | | Spalling of | 147 | |
| rolling | | the outer race | | |
| bearing) | | surface | | |

A transfer diagnostic task A←B is constructed based on the data sets A and B shown in Table 1 to verify the feasibility of the present invention, in order to identify the health state of the locomotive wheelset bearing by using the knowledge of rolling bearing fault diagnosis accumulated in the laboratory environment. In addition to the diagnostic accuracy, two imbalance classification metrics including the F-score and area under the curve (AUC) are employed to quantify the effect of the present invention on the transfer diagnostic task in consideration of the imbalanced samples in the vibration signal sample set B of the target rolling bearing. The experiment is repeated 10 times to calculate the statistical value of the diagnostic result. As shown in Table 2, the present invention uses partial diagnostic knowledge in the source rolling bearing to obtain the diagnostic accuracy of 97.48% on the vibration sample set of the target locomotive bearing and the statistical standard deviation of 2.03%. In addition, the indices F-score and AUC obtained by the present invention are 0.949 and 0.973, respectively, close to 1, which indicates that the method is of high diagnostic accuracy, and proves the feasibility of the present invention in solving the problem of domain imbalance transfer diagnosis in practical engineering.

TABLE 2
Comparison of diagnostic effects of different methods

| Diagnostic method | Accuracy (%) | F-score | AUC |
|---|---|---|---|
| The present invention | 97.48 ± 2.03 | 0.949 | 0.973 |
| Multiple polynomial kernel (MPK)- | 30.58 ± 4.89 | 0.263 | 0.497 |
| Residual network (ResNet) | | | |
| Standard ResNet | 15.79 ± 9.83 | 0.209 | 0.169 |

The MPK-ResNet and the standard ResNet are additionally selected and compared with the method of the present invention. The MPK-ResNet directly minimizes the multiple polynomial kernel induced maximum mean discrepancy of the fault features of the adaptation layer of the source rolling bearing and the target rolling bearing, and then uses the diagnostic model of the source rolling bearing to identify the health state of the target rolling bearing. Since the MPK-ResNet does not employ the domain asymmetry factor weighting of the present invention, the diagnostic accuracy of the MPK-ResNet is affected by the domain asymmetry and is only 30.58%, the standard deviation is 4.89%, the F-score is significantly lower than that of the present invention, and the AUC is close to 0.5, indicating that the performance of the traditional MPK-ResNet method is close to the random diagnostic model. The standard ResNet method uses the vibration signal sample set of the source rolling bearing to train the deep residual network, and then to directly identify the health state of the target rolling bearing. This method has a diagnostic accuracy of only 15.79%, the standard deviation is relatively high and is 9.83%, and the F-score and AUC indices are significantly lower than those of the present invention.

The comparison of the present invention with the conventional transfer diagnostic method (MPK-ResNet) and the standard deep intelligent diagnostic method (ResNet) indicates that the present invention effectively overcomes the influence of the domain asymmetry on the diagnostic knowledge transfer, thus improving the performance of the transfer diagnostic model.

What is claimed is:

1. A deep partial transfer method weighted by a domain asymmetry factor for a rolling bearing fault diagnosis, comprising the following steps:
step 1: obtaining a vibration signal sample set
$${\{ ( {x}_{m}^{s} , {y}_{m}^{s} ) \}}_{m = 1}^{{M}_{s}}$$
of a source rolling bearing in R types of health state, wherein xₘ^{s}∈ [symbol] ^{N×1} represents a m^{th} health state sample of the source rolling bearing and comprises N vibration data points; a sample label of the m^{th} health state sample of the source rolling bearing is yₘ^{s}∈{1, 2, 3, . . . R}; Mₛ represents a total number of vibration signal samples of the source rolling bearing, and s represents the source rolling bearing; and obtaining a vibration signal sample set {xₙ^{t}}ₙ₌₁^{M}^{ₜ} of a target rolling bearing, wherein xₙ^{t}∈ [symbol] ^{N×1} represents an n^{th} unlabeled health state sample of the target rolling bearing and comprises N vibration data points, Mₜ represents a total number of vibration signal samples of the target rolling bearing, and t represents the target rolling bearing;
step 2: building a domain-shared deep residual network, wherein a parameter to be trained in the domain-shared deep residual network is θ_{ResNet}, and extracting deep transfer fault features
$${\{ {x}_{m}^{s , {F}_{1}} \}}_{m = 1}^{{M}_{s}} and {\{ {x}_{n}^{t , {F}_{1}} \}}_{n = 1}^{{M}_{t}}$$
from the vibration signal sample set of the source rolling bearing and the vibration signal sample set of the target rolling bearing, respectively, wherein xₘ^{s,F}^{₁} represents a deep transfer fault feature of the m^{th} health state sample of the source rolling bearing; xₙ^{t,F}^{₁} represents a deep transfer fault feature of the n^{th} unlabeled health state sample of the target rolling bearing, and F₁ represents an F₁ layer of the domain-shared deep residual network;
step 3: building a parameter-shared domain confusion network, wherein a parameter to be trained in the parameter-shared domain confusion network is θ_{adv}; an input of the parameter-shared domain confusion network is the deep transfer fault features
$${\{ {x}_{m}^{s , {F}_{1}} \}}_{m = 1}^{{M}_{s}} and {\{ {x}_{n}^{t , {F}_{1}} \}}_{n = 1}^{{M}_{t}} ,$$
and an output of the parameter-shared domain confusion network is domain confusion features
$${\{ {x}_{m}^{s , adv} \}}_{m = 1}^{{M}_{s}} and {\{ {x}_{n}^{t , adv} \}}_{n = 1}^{{M}_{t}} ;$$
wherein xₘ^{s,adv} represents an m^{th} domain confusion feature of the health state sample of the source rolling bearing; xₙ^{t,adv} represents a domain confusion feature of the n^{th} unlabeled health state sample of the target rolling bearing; adv represents the parameter-shared domain confusion network; and maximizing the following objective function to update the parameter θ_{adv} of the parameter-shared domain confusion network:
$${max}_{θ} {\sum }_{m = 1}^{{M}_{s}} {x}_{m}^{s , adv} - {\sum }_{n = 1}^{{M}_{t}} {x}_{n}^{t , adv}$$
wherein after the parameter θ_{adv} is updated in each iteration, the parameter θ_{adv} to be trained in the parameter-shared domain confusion network is truncated within a range of {−ξ, ξ};
step 4: after the parameter θ_{adv} to be trained in the parameter-shared domain confusion network is iteratively updated n_{adv} times in step 3, calculating a domain asymmetry factor ρₘ^{sn} of the deep transfer feature of the m^{th} health state sample of the source rolling bearing;
step 5: extracting fault features
$${\{ {x}_{m}^{s , {F}_{2}} \}}_{m = 1}^{{M}_{s}} and {\{ {x}_{n}^{t , {F}_{2}} \}}_{n = 1}^{{M}_{t}}$$
of an adaptation layer of an F₂ layer of the parameter-shared deep residual network, wherein xₘ^{s,F}^{₂} represents a fault feature of the adaptation layer of the m^{th} health state sample of the source rolling bearing, xₙ^{s,F}^{₂} represents an n^{th} fault feature of the adaptation layer of the unlabeled health state sample of the target rolling bearing, and F₂ represents the F₂ layer (a feature adaptation layer) of the domain-shared deep residual network; and calculating a maximum mean discrepancy D(X^{s}, X^{t}), and the maximum mean discrepancy D (X^{s}, X^{t}) is implanted by multiple polynomial kernels of adaptation layer features by weighting the domain asymmetry factor obtained in step 4:
$$D ( {X}^{s} , {X}^{t} ) = {\sum }_{u = 1}^{U} {β}_{u} D ( {X}^{s} , {X}^{t} \text{;} {a}_{u} ) = {\sum }_{u = 1}^{U} {β}_{u} [ \begin{matrix}\frac{1}{{M}_{s}^{2}} {\sum }_{i = 1}^{{M}_{s}} {\sum }_{j = 1}^{{M}_{s}} {ρ}_{i}^{s} {ρ}_{j}^{s} k ( {x}_{i}^{s , {F}_{2}} , {x}_{j}^{s , {F}_{2}} \text{;} {a}_{u} ) + \frac{1}{{M}_{t}^{2}} {\sum }_{i = 1}^{{M}_{t}} {\sum }_{j = 1}^{{M}_{t}} k ( {x}_{i}^{t , {F}_{2}} , {x}_{j}^{t , {F}_{2}} \text{;} {a}_{u} ) \\ - \frac{2}{{M}_{s} {M}_{t}} {\sum }_{i = 1}^{{M}_{s}} {\sum }_{j = 1}^{{M}_{t}} {ρ}_{i}^{s} k ( {x}_{i}^{t , {F}_{2}} , {x}_{j}^{t , {F}_{2}} \text{;} {a}_{u} )\end{matrix} ]$$
wherein, k (⋅,⋅) represents a polynomial kernel function; aᵤ represents a slope of a u^{th} polynomial kernel function; U represents a number of implanted polynomial kernel functions; βᵤ represents a weighting coefficient of the maximum mean discrepancy, and the maximum mean discrepancy is implanted by the u^{th} polynomial kernel, and βᵤ∈β*, where β* represents an optimal weighting coefficient and is obtained by solving the following optimization problem:
$${β}^{*} = {arg max}_{{β}_{u}} \frac{{\sum }_{u = 1}^{U} {β}_{u} D ( {X}^{s} , {X}^{t} \text{;} {a}_{u} )}{\sqrt{\frac{1}{U} {\sum }_{u = 1}^{U} {[ {β}_{u} D ( {X}^{s} , {X}^{t} \text{;} {a}_{u} ) - \frac{1}{U} {\sum }_{u = 1}^{U} {β}_{u} D ( {X}^{s} , {X}^{t} \text{;} {a}_{u} ) ]}^{2}}} wherein , \\ {\sum }_{u = 1}^{U} {β}_{u} = 1 , \\ and {β}_{u} \geq 0.$$
step 6: predicting probability distributions
$${\{ {P}_{m}^{s , {F}_{3}} \}}_{m = 1}^{{M}_{s}} and {\{ {P}_{n}^{t , {F}_{3}} \}}_{n = 1}^{{M}_{t}}$$
of a F₃ layer feature of the domain-shared deep residual network belonging to a health state of the source rolling bearing by a Softmax activation function, wherein Pₘ^{s,F}^{₃} represents a predicted probability distribution of a health state of an m^{th} vibration sample of the source rolling bearing, and Pₙ^{s,F}^{₃} represents a predicted probability distribution of a health state of an n^{th} vibration sample of the target rolling bearing, and F₃ represents an output layer F₃ layer of the domain-shared deep residual network; and minimizing the following objective function to update the parameter θ_{adv} to be trained in the domain-shared deep residual network by combining the maximum mean discrepancy implanted by the multiple polynomial kernels obtained in step 5:
$${min}_{θ} - \frac{1}{{M}_{s}} {\sum }_{m = 1}^{{M}_{s}} {\sum }_{j = 1}^{R} I ( {y}_{m}^{s} = j ) log {P}_{m}^{s , {F}_{3}} + λ \cdot D ( {X}^{s} , {X}^{t} )$$
wherein, λ represents a tradeoff parameter for a training of the domain-shared deep residual network; and
step 7: repeating steps 3-6 in sequence to train a partial transfer diagnostic model, and the partial transfer diagnostic model is combined by a training domain and a deep confusion network; after the training of partial transfer diagnostic model is done, inputting an n^{th} unlabeled health sample xₙ^{t} of the target rolling bearing into the domain-shared deep residual network of the partial transfer diagnostic model; selecting a health label corresponding to a maximum probability value in the predicted probability distribution Pₙ^{t,F}^{₃} of the health state of the n^{th} vibration sample of the target rolling bearing output by the deep confusion network as a health state of the n^{th} unlabeled health sample xₙ^{t} of the target rolling bearing.
